(19) United States
(12) Patent Application Publication
(10) Pub. No.: US 2015/0329162 A1
(43) Pub. Date: Nov. 19, 2015

(54) SHIELD FOR ROAD BICYCLE HANDLEBARS

(71) Applicant: Jay Austin Small, JR., Vancouver, WA (US)

(72) Inventor: Jay Austin Small, JR., Vancouver, WA (US)

(21) Appl. No.: 14/279,400

(22) Filed: May 16, 2014

(51) Int. Cl. B62J 23/00; F16B 1/00

(52) U.S. Cl. CPC B62J 23/00; F16B 1/0014

(57) ABSTRACT

A handlebar shield device for attachment to road bicycle handlebars and a means of attachment is disclosed. The shield is comprised of a plurality of somewhat rigid shell components covering the control levers and some portions of the handle bars so that a rider's hands are protected from driving rain. The shield is attached to the handlebar by means of attachment to an auxiliary bar which is then attached to the bicycle handle bar. The said shield covers some or all sections of the handlebar made to be gripped by the rider.

### FIELD

The disclosure pertains to a shield accessory for road type bicycle handlebars.

### BACKGROUND

The present invention relates to a bicycle handlebar shield attached to road bike style drop handlebars, and a means of attachment.

The problem for cyclist athletes to remain reasonably comfortable during vigorous riding in rain is well appreciated and difficult to successfully address. This is because any solution must at once shield the athlete from rain but, equally important, allow moisture from exertion to escape from around the skin, otherwise normal sweating saturates clothing on the inside. Shielding rain is usually a simple matter, as many materials are impervious to water. But as those skilled in the art will acknowledge, accomplishing this while also including a provision for moving saturation from the skin is generally the challenge and that both functions must be met before any solution is considered successful.

Soggy trapped perspiration and the overheating sensation there from is as equally objectionable as having no rain protection at all. With the advent of so-called waterproof-breathable fabrics, however, such as disclosed in AU 1999/010284 WATERPROOF BREATHABLE LAMINATE by W.L. Gore and Associates GMBH, which allow vaporous but not liquid water to pass through them, most successful solutions for athletic cycling in rain are offered in the form of clothing. These well known fabrics are comprised in virtually all wearable rain protective products for cycling. However, it is also known to those skilled in the art that these fabric technologies alone are not adequate to manage moisture generated from strenuous activities, as they do not vent saturated air fast enough to prevent excessive sweating. It is for this reason that cycling rain clothing such as jackets and pants, include zippered venting features. However, unlike jackets and pants, which have adequate surface area to strategically place venting features, no such accommodations can be made for gloves so they saturate very quickly from perspiration.

Some prior arts have suggested frontal shielding attached to the bicycle, as in U.S. Pat. No. 4,655,497 to G. L. Mallet entitled FAIRING FOR BICYCLES AND THE LIKE, and U.S. Pat. No. 4,066,290 to G. A. Wiegert and J. R. Negele entitled BICYCLE FAIRING. These arts suggest relatively large frontal coverage fairings intended more for aerodynamics rather than rain protection. As anyone skilled in the art will observe, these and similar configurations simply do not provide adequate sheltering of the hands from rain fall. Other handlebar attached devices have been marketed primarily for cold protection, one of which encapsulates the hands entirely in an insulating pouch, another in which small fairings cover the hands in frontal but not meridional directions. The former, while sheltering the hand from direct rain fall, is much too prone to cause excessive sweating in temperatures possible for rain and omits a means of venting. The later device simply does not shield enough for rain protection and leaves the hands completely exposed to rain while operating controls.

A solution is therefore required that can offer a road cyclist athlete hand protection and comfort while riding in rain that both shields the hands from direct rain water and prevents excessive sweating about the hands by a means of venting saturated air. Such a solution is needed that performs both these functions while operating brake controls so that the hands never have to be exposed to driving rain. As well, the devices should be easily attached and removed, preferably without tools, and exhibit no interference with the road bike handlebar's normal accessibility.

### SUMMARY OF THE INVENTION

Primarily, the object of the present Invention is to provide a handlebar mounted shelter for the hands to prevent gloves and hands from becoming saturated from airborne moisture while cycling in rainy weather. The invention also objects to prevent glove saturation due to excess perspiration from exertion by providing adequate ventilation to the hands, functioning with equal effectiveness in dry and wet weather conditions which can often occur on the same ride. A further object is to be compatible with road bike style drop handlebars and protect the rider's hands while actuating the controls and without limiting access to any part of the handlebar. A final object is to accomplish these with a device that is compatible with nearly all manufacturers of handlebars and shift/brake control components and combinations thereof.

In the preferred embodiment of the invention, the shield is comprised of a pair of thin lightweight, flexibly ridged shells, each forming a closely fitting cavity substantially above and forward of the brake control handles, the cavity opening facing primarily downward and somewhat towards the rider such that the hands are easily inserted into and withdrawn from the cavity. In this configuration the shell components provide shielding to the hands from rain water and wind chill as the rider grips the brake lever handles. The shell components are generally aerodynamic so as to remain in a stable configuration at cycling speeds. In some examples, the shell components extend towards the rider so as to encompass hand grip positions along top portion of the handlebar. In the preferred embodiment, coverage extends only to the rider's wrist when grasping the brake control handles, so that some riding positions are sufficiently protected during periods of rain and others are uncovered allowing for cooling of the hands.

Removable attachment of the shield device is accomplished in part by a stiff cross member configured to be situated between the two brake control handles, its ends disposing generally at the midpoints thereof. The cross member is removably attached to the handlebars by means of an adapter device, one fixedly attached at each end thereto. The adapter device is comprised of a light robust material configured with a surface feature that generally conforms to both the handlebar tubing radius and the arc formed by the underside of the handlebar hook section. Extending from the lateral edges of the said surface feature are a plurality of hook features configured to receive an elastically stretchable material such as a rubber o-ring. It is to be understood that further reference to o-ring is to represent any suitable elastically stretchable material and configuration thereof permitting the attachment mechanism as described. Thus, the o-ring is retained by a first hook, routed around the brake control handle body along its base then retained by at least a second hook, securing the adaptor and thus the cross member firmly to the handlebar. The shell components are in turn fixedly attached to the cross member using brackets and screws.

The shells are additionally comprised each of a second means of removable attachment, wherein a plurality of hooks or some other appropriate retaining structure is fixedly attached to the underside of the shell and disposed in close contact with the top of the said brake control handle. Attachment is achieved by looping one end the said o-ring onto one of the said hooks then routing the o-ring between the control handle and brake lever connected thereto. The o-ring is then looped onto the remaining hook securing the shell body to the brake handle and thus to the bicycle handle bar.

It will be appreciated from the foregoing that the handlebar shield of the present invention provides a previously unavailable means of hand protection for road cyclists riding vigorously in the rain. In particular the shield is light in weight, of compact size to restrict both direct and buffeting airborne water, and removably attaches to virtually all classical road bike handle bars and brakes levers regardless of size. Other aspects of the invention along with those mentioned above will become readily apparent in the more detailed description which follows, taken in conjunction with the accompanying drawings.

### BRIEF DESCRIPTION OF THE DRAWINGS

FIG. 1 is a perspective view of a handlebar shield embodying the present invention, a cyclist, and a bicycle.

FIG. 2 is perspective view of the shield device as mounted to a dropped style bicycle handlebar, with both side shown.

FIG. 3 is an enlarged view of one side of the embodying shield showing mounting details.

FIG. 4 is an enlarged view of the underside of the handlebar showing details of the bar clamp adaptor.

FIG. 5 is an isolated view of the bar clamp adaptor.

FIG. 6 is a detailed view of a hooking feature with o-ring retaining clasp.

### DETAILED DESCRIPTION OF THE PREFERRED EMBODIMENT

The following disclosure is presented in the context of representative embodiments that are not to be construed as being limiting in any way. This disclosure is directed toward all novel and non-obvious features and aspects of the various disclosed embodiments, alone and in various combinations and sub-combinations with one another. The disclosed methods, apparatus, and systems are not limited to any specific aspect or feature or combination thereof, nor do the disclosed embodiments require that any one or more specific advantages be present or problems be solved.

Although the operations of the disclosed methods are described in a particular, sequential order for convenient presentation, it should be understood that this manner of description encompasses rearrangement of the operations, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other things and methods.

This disclosure sometimes uses terms like “produce,” “generate,” “select,” “receive,” and “provide” to describe the disclosed methods. These terms are high-level abstractions of the actual operations that are performed. The actual operations that correspond to these terms may vary depending on the particular implementation and are readily discernible by one of ordinary skill in the art. The singular forms “a,” “an,” and “the” include the plural forms unless the context clearly dictates otherwise. The term “includes” means “comprises.” Certain terms may be used such as “up,” “down,” “upper,” “lower,” and the like. These terms are used, where applicable, to provide some clarity of description when dealing with relative relationships. But, these terms are not intended to imply absolute relationships, positions, and/or orientations. The term “or” refers to a single element of stated alternative elements or a combination of two or more elements, unless the context clearly indicates otherwise. The materials, methods, and examples are illustrative only and not intended to be limiting. Other features of the disclosure are apparent from the following detailed description and the claims. Unless otherwise indicated, all numbers expressing quantities of components, percentages, temperatures, times, and so forth, as used in the specification or claims are to be understood as being modified by the term “about” or “approximately.”

In the following embodiment examples indications are referenced to the drawings sometimes for only one side of the handlebar. It is to be understood that the device of the preferred embodiments are represented in completion by a pair of distinctly attached assemblies, one being substantially the mirror version of the other about the vertical plane containing the bicycle stem, and so references to one side is to be understood to refer to the other unless explicitly noted.

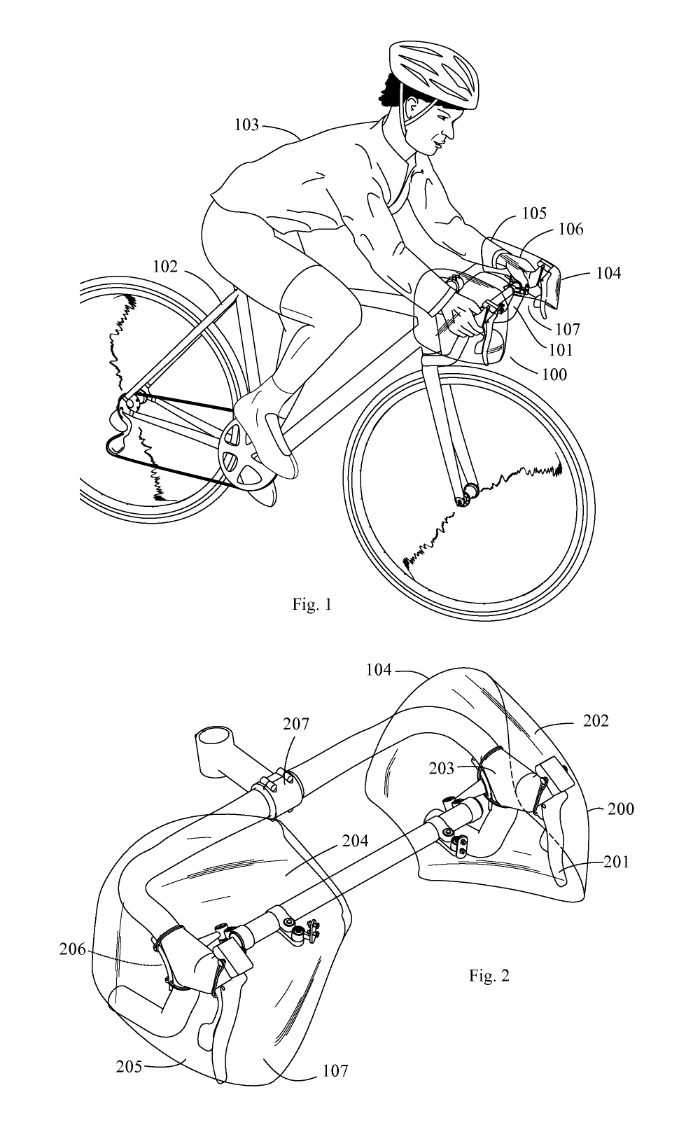

FIG. 1 is one example of an embodiment of a shield 100 for road bike dropped style handlebars 101 which are conventionally mounted to a road bicycle 102 showing a rider 103 in a conventional riding posture. In this example a rain shield for handlebars comprising a pair of flexibly rigid molded shell coverings 104 is mounted to the handlebars 101 using two attach points per handlebar side as will be further described herein. The shells are sized to compactly surround the hands 105, thus their small size will not obstruct the rider's view ahead. Therefore, the shells may be made from either transparent or opaque materials. In the described examples, a shield device minimizes moisture accumulation about the hands 105 while riding in wet weather by first directly blocking rain or mist and secondly by facilitating evaporation of perspiration from the hands through ventilation. Thus, in accordance with the invention, the shield is compactly situated to the handlebars 101 to prevent buffeting wind from carrying atmospheric moisture to the inside of the shield, while also providing the rider unhindered access to conventional grip locations on the handlebar 101. While not a primary function of drag reduction, the shells of the preferred embodiment comprise smooth, sloped surfaces to reduce turbulence about the shell's open regions 107.

In accordance to the claims of the invention as shown in FIG. 2, a shield leading apex 200 covers the brake lever 201 from forwardly driven moisture when the bicycle is in motion. A dorsal apex 202 and an outside apex 205 shield the brake hood 203 and the rider's wrist 105 and hand 106 when gripping thereon.

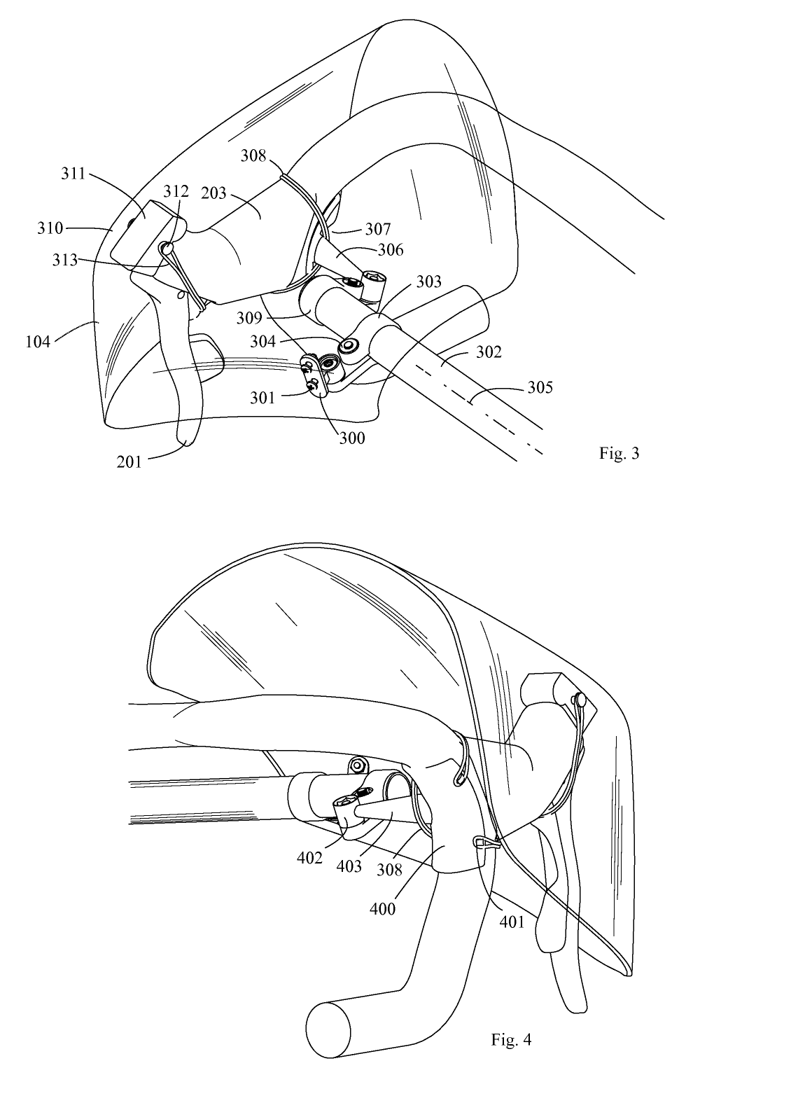

Thus in the preferred embodiment the shell covering 104 generally surrounds the handlebar hook section 206 of the handlebar. An inner lobe covering 204 is comprised primarily of a substantially horizontal upper shell surface that shelters direct impact from side spray while providing clearance for some shifter designs which require pivoting of the brake lever 201 towards a vertical plane containing the bicycle stem 207. Inner lobe 204 also serves to structurally stabilize the shell 104 as shown in FIG. 3 by fixed attachment to a suitable bracket 300 with nuts and bolts 301, the bracket 300 in turn fixedly attached to a rigid mounting rod 302 by a clamp 303 secured with a nut and bolt 304, so as to prevent rotation about the mounting rod axis 305.

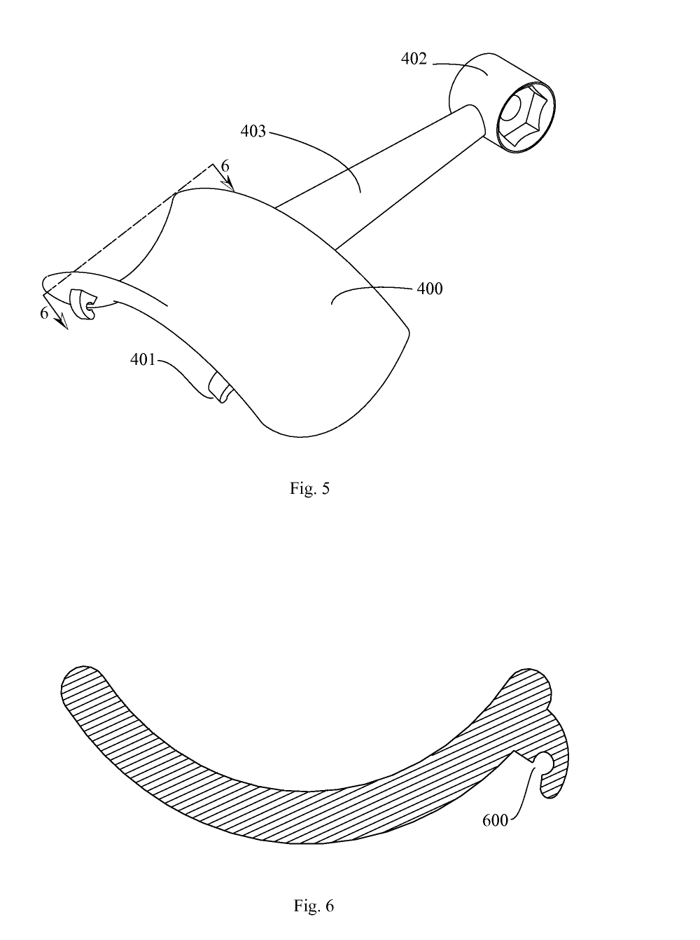

Rotational stability of the mounting rod 302 is achieved by its fixed attachment to a bar adaptor 306, described in more detail herein, which when removably attached to the handlebar 101 prevents movement of the mounting rod 302 and importantly, the shield cover 104 supported thereon. The bar adaptor 306 in accordance to the claims of the invention, provides a key means of removable attachment that secures the shield device 100 but is also easily fastened by the user without tools or damaging clamps. As such, the bar adaptor 306 uniquely situates on the underside of the handle bar hook section 307 beneath and opposite the brake hood 203 and is secured to the handlebar with a rubber o-ring 308. Referring to FIGS. 4 and 5, in the preferred example the adaptor 306 comprises a conforming body 400 configured with pair of hooking features 401 on its outer edge suitably configured accept the o-ring 308. The opposing side of the conforming body 400 includes a mounting boss, 402 at the end of an extension member 403, providing a means of fixed attachment to the bar adaptor 306 to clamp 309. The o-ring ends are secured by the hooks 401 after first looping around the brake hood 203 and under the extension member 403 so as to firmly hold the adaptor 306 in place. For convenience to the user, at least one of the hooking features 401 is configured with a molded clasp gap 600, shown in detail in FIG. 6, that is slightly smaller than the o-ring material diameter so that it remains connected to the shield device when not in use and does not become lost.

While bracket 300 secures the left or right shell 104 towards the vertical plane containing the bicycle stem 207, in the preferred embodiment a second attach point 310 secures the shells at the outer ends of the handlebar, directly over the brake hood 203, achieving a stable yet removable joining mechanism again requiring no tools. Details of the hood attachment, as illustrated in FIG. 3, comprises a spacer block 311 fixedly attached to inner side of the shell covering 104 and configured with a pair of hooking features 312 spanning approximately the width of the brake hood 203. Attachment thereon is achieved by stretching a rubber o-ring 313 between the brake hood 203 and brake lever 201, looping each end of the o-ring 313 onto spacer block hooking features 312, securing the shell covering 104 securely but removably to the brake hood 203. A similar clasp gap 600 can be applied to the hooking features 312 for the same purpose of retaining o-ring 313 when the shield device is not in use.

In the embodiment described herein, the shield provides rain Mocking functions to the hands while also providing a high degree of ventilation so that the hands do not overheat or become otherwise saturated when wearing gloves. This is accomplished as described herein by inclusion of surfaces covering the front, top, and sides of the handlebar but not the bottom and rear, which remain largely open to the air below, respectively promoting air exchange within the shield interior, and providing access the brake and shifter controls. The uncovered areas are resistant to moisture infiltration by air turbulence or wind due to the shield's compact extent and because they do not encounter direct water impact. Thus this configuration provides an important and non-obvious benefit of adequate ventilation required to evaporate hand moisture.

In view of the many possible embodiments to which the principles of the disclosure may be applied, it should be recognized that the illustrated embodiments are only preferred examples and should not be taken as limiting the scope of the disclosure. We therefore claim as our invention all that comes within the scope and spirit of the appended claims.

1. A shield device for road bicycle handlebars comprising a plurality of impermeable shield coverings which when taken together comprise
a: a dorsal apex, closely juxtaposed above each brake control handle and configured with sufficient length to shield rain to a rider's hand and wrist when grasping thereon,
b: a leading apex situated forward and in close proximity to each brake lever and configured with sufficient length to substantially cover the same, preventing impact of rain thereto,
c: an outer apex situated about the outside of each handlebar reach section and connectively configured to the said dorsal and leading apexes to form a shell protective of water impingement from the forward, downward and sideways directions,
d: a substantially open lower face, having a boundary defined by the edges of the said dorsal, leading, and outer apexes and configured with sufficient area to permit air exchange there through.

2. The shield of claim 1, wherein the said shield device further comprises a rigid cross member, the said shield coverings fixedly attached thereto, wherein the said cross member is juxtaposed between the hook sections of said handlebars.

3. The shield of claim 2 further comprising a plurality of mounting adaptors configured to fixedly attach to the said rigid cross member and removably attach to the said handlebar.

4. The shield of claim 3 wherein the said adaptors are configured to removably attach to each said handlebar hook section and comprises:
a: a conforming body configured to conform substantially to the underside of the said handlebar hook section with sufficient length to prohibit rotation within a hook section plane, the plane containing the said handlebar hook section and the handlebar drop section, wherein the said conforming body is further configured to substantially conform to the handlebar tubing radius with sufficient width to impair the said conforming body from sliding out of the said hook section plane when in forced contact with the said handlebar.
b: An extension member disposing substantially normal to the said hook section plane and with sufficient length to permit connectivity with the said rigid cross member thereto.

5. A removable adaptor device for dropped style road bicycle handlebars for providing a mounting structure for the attachment of accessories thereon comprising:
a: a conforming body configured to conform generally to the underside of the handlebar hook section with sufficient length to prohibit rotation within a hook section plane, the plane containing the said handlebar hook section and the handlebar drop section, and further configured to generally conform to the handlebar tubing radius with sufficient width and curvature to impair the said conforming body from slipping out of the said hook section plane when in forced contact with the said handlebar.
b: a plurality of retention features suitable to receive the end of a stretchable fastener.
c: a plurality of stretchable fasteners configured to couple to the said retention features and to loop around the said handlebar, securing the said adaptor device to the said handlebar.
d: an attachment feature rigidly disposed from said conforming body and configured to receive an attachable device compatibly configure therewith.

6. The shield of claim 1 further comprising:
a: a mounting feature fixedly attached to the underside of said shell covering, disposed in contact with the said brake control handle and configured with a plurality of retention features configured to receive the end of a stretchable fastener.
b: a plurality of stretchable fasteners configured to couple to the said retention features and loop between the said brake control handle and said brake lever securing the said shell covering to the said brake control handle.

7. The shield of claim 2 wherein the said rigid cross member length is between 9 and 13 inches.

8. The bar adaptor of claim 5 further comprising:
a: a void within the said hooking feature configured to circumscribe the cross section of said stretchable fastener wherein the said void is disposed near the edge of the said hooking feature.
b: a passage way into the said void with a gap dimension slightly less than smallest cross sectional dimension of said stretchable fastener.

9. The bar adaptor of claim 5 further comprising a rigid cross member configured to connectively join the same.

10. The shield device of claim 1 wherein the leading apex length is 4 to 7 inches.

11. The shield device of claim 1 wherein the dorsal apex length is 5 to 10 inches.

12. The bar adaptor of claim 5 wherein the adaptor is fabricated of molded plastic.

13. The bar adaptor of claim 5 wherein the adaptor is fabricated of carbon fiber.

14. The shield of claim 1, wherein the said shield coverings are made of polycarbonate.

15. The shield of claim 1, wherein the said shield coverings are made at least in part from molded plastic.

16. The shield of claim 1, wherein the said shield coverings are made at least in part from carbon fiber.

17. The shield device of claim 2, wherein the said rigid cross member is made of carbon fiber.

18. The shield of claim 2, wherein the said cross member is made of aluminum.
